(19) United States
(12) Patent Application Publication
(10) Pub. No.: US 2005/0147312 A1
(43) Pub. Date: Jul. 7, 2005

(54) Method and apparatus for creating vector representation

(76) Inventor: Aubrey Kuang-Yu Chen, Taipei (TW)

Correspondence Address: BIRCH STEWART KOLASCH & BIRCH, PO BOX 747, FALLS CHURCH, VA, 22040-0747, US

(21) Appl. No.: 10/751,411

(22) Filed: Jan. 6, 2004

(51) Int. Cl. G06K 9/36

(52) U.S. Cl. 382/242

(57) ABSTRACT

A method for creating a vector representation of a image. The method includes acquiring position information for two nodes of the image from user input, determining a curve sketching a segment of an outline of the image between the two nodes, acquiring position information of a new node on the image from additional user input, determining another curve sketching another segment of the outline of the image between the new node and the node where the previous curve ends, and repeating the determination step until the outline of the image is completely sketched.

### BACKGROUND OF THE INVENTION

1. Field of the Invention

The present invention relates to rendering of vector graphics and particularly to a method for quickly creating a vector representation of a bitmap image.

2. Description of the Related Art

Computer graphics can be divided into two broad categories, raster and vector. These categories differ primarily in the manner that drawing data is created, stored, and edited. Raster graphics, often called bitmaps, are two dimensional arrays of picture elements. Similar to grains in a photograph, each picture element (pixel) has a color value. The collection of these pixels and their corresponding values form a raster image.

In contrast, vector graphics are based on a definition of geometric shapes. Shapes are defined by precise mathematically defined Cartesian points. Thus, the shapes may be lines, rectangles, curves, or any arbitrary polygon defined by mathematical points. The collection of these geometric shapes and their mathematical definitions form a computer vector drawing.

One of the biggest problems in vector drawing is creation of a representation for an existing bitmap image or how a set of vector curves that best represent that bitmap sketch can be found.

In some conventional software applications for vector drawing, the user is allowed to manually draw and fit the vector curves to the outline of the bitmap image. First, a curve roughly sketching a segment of the outline of the bitmap image is drawn. Second, for improvement of the fit between the curve and the outline of the bitmap image, the parameters of the curve are modified by dragging the curve. The first and second steps are repeated until all the curves completely sketching the outline of the bitmap image are drawn.

There are several drawbacks to the described method. One is that dragging the curve to modify the curve parameters is tedious and disrupts the workflow. Another is that both the start and end points must be determined by the user each time the curve is drawn even though the start point is often identical to the end point of the previously drawn curve.

Some other conventional software applications provide automatic tracing of the outline for vector drawing, in which the outline of a bitmap image is rendered automatically without any user input. However, automatic tracing algorithms are error-prone and do not always produce optimal results, particularly for complicated bitmap images from photographs.

### SUMMARY OF THE INVENTION

The object of the present invention is to provide a method for quickly creating a vector representation of a bitmap image.

The present invention provides a method for creating a vector representation of a image. The method includes the steps of acquiring position information for two nodes of the image from user input, determining a curve sketching a segment of an outline of the image between the two nodes, acquiring position information of a new node on the image from additional user input, determining another curve sketching another segment of the outline of the image between the new node and the node where the previous curve ends, and repeating the determination step until the outline of the image is completely sketched.

The present invention also provides an apparatus for creating a vector representation of a image. The apparatus includes means for acquiring position information of pairs of nodes in the image from user input, and means for determining a curve sketching a segment of an outline of the image between each pair of the nodes.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 is a flowchart of a method for creating a vector representation of a bitmap image according to one embodiment of the invention.

FIGS. 2A˜2G show examples of the results produced by a method for creating a vector representation of a bitmap image according to one embodiment of the invention.

### DETAILED DESCRIPTION OF THE INVENTION

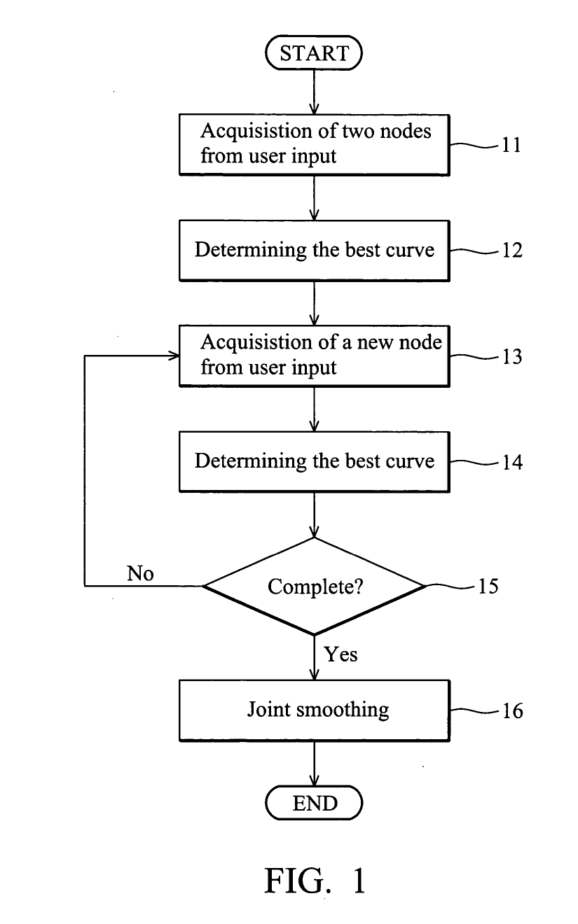

FIG. 1 is a flowchart of a method for creating a vector representation of a bitmap image according to one embodiment of the invention, which is implemented with a computer system.

In step 11, position information for two nodes of the image is acquired from user input.

In step 12, a curve sketching a segment of an outline of the image between the two nodes is determined. First, a vector flow of the image between the two nodes is determined by a tracing algorithm to extract a number of sample points. Second, a function describing the sample points is determined by a curve-fitting algorithm, such as Simple Curve Fitting algorithm provided by Sterling Paramore. Finally, the function is adopted to one describing a cubic Bezier curve. The final function mathematically represents the resulting curve.

In step 13, position information of a new node on the image is acquired from additional user input.

In step 14, another curve sketching another segment of the outline of the image between the new node and the node where the previous curve ends is determined. The new curve is determined by the same sub-steps in step 12.

In step 15, it is determined by whether the outline of the bitmap image is completely sketched. If so, the procedure returns to step 13; otherwise, the procedure goes to step 16.

In step 16, joints of the curves sketching the outline of the image are smoothed.

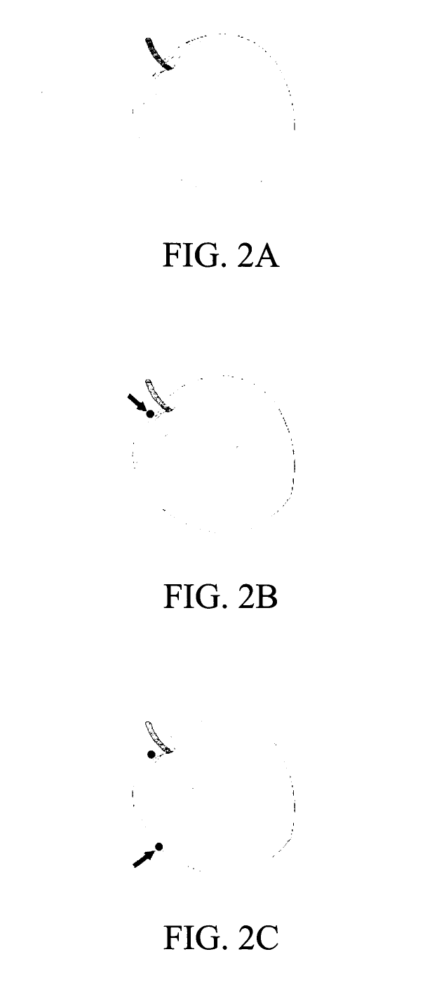

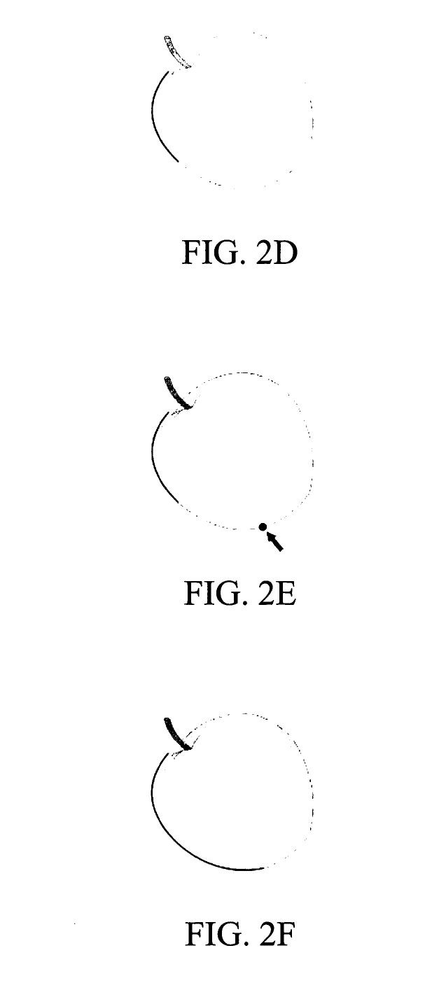

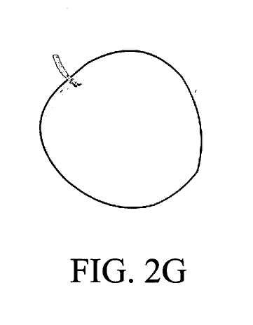

FIGS. 2A˜2G show examples of the results produced by the previously described method.

As shown in FIG. 2A, a bitmap image is provided. The vector sketch begins with identification of the first pair of nodes (start and end nodes) of a vector curve that best describe the respective curve segment in the underlying bitmap image, as shown in FIGS. 2B and 2C.

As shown in FIG. 2D, the curve-fitting algorithm is applied to automatically determine the parameters of the first pair of nodes provided by in FIGS. 2B and 2C. The parameters accurately correspond to the respective curve segment in the underlying bitmap image. First, the vector flow of the outline of the underlying image between the two nodes identified in FIGS. 2B and 2C is determined by a tracing algorithm in order to extract a number of sample points describing the curve segment in the underlying bitmap image. Second, a function that describes the behavior of the sample points is determined by Simple Curve Fitting algorithm. Finally, the resulting function is adopted to one describing a cubic Bezier curve. The Bezier curve is the first curve in the set of vector curves that describe the bitmap sketch.

As shown in FIG. 2E, the user identifies the end node of the next pair of nodes of a vector curve that best describe the next respective curve segment in the underlying image. Position information on the start node of this pair of nodes of the vector curve is carried over from the end node of the previous pair of nodes.

As shown in FIG. 2F, the curve-fitting algorithm is again applied to automatically determine the parameters of the new pair of nodes that accurately correspond to the respective curve segment in the underlying bitmap image.

As shown in FIG. 2G, as the user identifies all the nodes and all the curves are automatically produced by the curve-fitting algorithm, the sketch is complete. The final output is a set of vector curves that describes the bitmap sketch optionally, an algorithm for smoothing a number of curve joints can be applied to produce a smoother set of vector curves.

In conclusion, the present invention provides a method for quickly creating a vector representation of a bitmap image. In the invention, critical nodes in a sketch of the outline of a bitmap image are quickly identified by the user to minimize the number of nodes, which reduces rendering complexity. The curve-fitting algorithm automatically identifies the best parameters of the curve having the nodes determined by, which eliminates tedious modification by dragging the curve.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

1. A method for creating a vector representation of a image, the method comprising the steps of:
acquiring position information for two nodes of the image from user input;
determining a curve sketching a segment of an outline of the image between the two nodes;
acquiring position information of a new node on the image from additional user input;
determining another curve sketching another segment of the outline of the image between the new node and the node where the previous curve ends; and
repeating the determination step until the outline of the image is completely sketched.

2. The method as claimed in claim 1, wherein the image is a bitmap image.

3. The method as claimed in claim 1, wherein the curve sketching one segment of the outline of the image between two of the nodes acquired from user input is determined by the steps of:
determining a vector flow of the image between the two nodes by a tracing algorithm to extract a number of sample points;
determining a function describing the sample points by a curve-fitting algorithm; and
adopting the function to one describing a cubic Bezier curve.

4. The method as claimed in claim 3, wherein the curve-fitting algorithm is Simple Curve Fitting algorithm.

5. The method as claimed in claim 1 further comprising smoothing joints of the curves sketching the outline of the image.

6. An apparatus for creating a vector representation of a image, the apparatus comprising:
means for acquiring position information for pairs of nodes of the image from user input; and
means for determining a curve sketching a segment of an outline of the image between each pair of nodes.

7. The apparatus as claimed in claim 6, wherein the image is a bitmap image.

8. The apparatus as claimed in claim 6, wherein the curve determining means comprises:
means for determining a vector flow of the image between the two nodes by a tracing algorithm to extract a number of sample points;
means for determining a function describing the sample points by a curve-fitting algorithm; and
means for adopting the function to one describing a cubic Bezier curve.

9. The apparatus as claimed in claim 8, wherein the curve-fitting algorithm is Simple Curve Fitting algorithm.

10. The apparatus as claimed in claim 6 further comprising means for smoothing joints of the curves sketching the outline of the image.
